(19) United States
(12) Patent Application Publication
(10) Pub. No.: US 2012/0054009 A1
(43) Pub. Date: Mar. 1, 2012

(54) Joining User Lists With External Data

(76) Inventors: Vadim Furman, San Jose, CA (US); Rajas Moonka, San Ramon, CA (US); Anurag Agarwal, Sunnyvale, CA (US); Raghava Hassan Nanjunda Swamy, Sunnyvale, CA (US); Oren E. Zamir, Los Altos, CA (US)

(21) Appl. No.: 13/222,535

(22) Filed: Aug. 31, 2011

Related U.S. Application Data
(60) Provisional application No. 61/379,289, filed on Sep. 1, 2010.
(60) Provisional application No. 61/379,384, filed on Sep. 1, 2010.

(51) Int. Cl. G06Q 30/02

(52) U.S. Cl. 705/14.5; 705/14.55; 705/14.57; 705/14.66; 705/14.71

(57) ABSTRACT

A computer-implemented method comprises receiving a request for content from a user, determining a user list associated with the user, the user list including a definition that characterizes members of the user list, determining additional data related to a context associated with the user, and providing user list definition data and the additional data along with the request to a consumer that has subscribed to the user list.

### CROSS REFERENCE TO RELATED APPLICATIONS

This patent application claims the benefit of priority of U.S. Provisional Patent Application No. 61/379,289, filed Sep. 1, 2010 and U.S. Provisional Patent Application No. 61/379,384, filed Sep. 1, 2010. The content of both U.S. Provisional Patent Application No. 61/379,289 and U.S. Provisional Patent Application No. 61/379,384 is hereby incorporated by reference into this application as if set forth herein in full.

### TECHNICAL FIELD

This document relates to presenting content.

### BACKGROUND

Providing relevant advertising content to users is generally important to advertisers and service providers. However, implementing a cost-effective way of providing such relevant advertising content can prove difficult in an ever-changing online market. Further, while relevant information for targeting a particular user may be known by one entity, others may not readily have access to or be able to use such information when, for example, making targeting decisions.

### SUMMARY

This document discusses systems and techniques by which user lists are joined with external data.

In one aspect, a computer-implemented method comprises receiving a request for content from a user, determining a user list associated with the user, the user list including a definition that characterizes members of the user list, determining additional data related to a context associated with the user, and providing user list definition data and the additional data along with the request to a consumer that has subscribed to the user list.

Implementations can include any, all, or none of the following features. The request is a request for an ad to be displayed to the user and where the consumer is an advertiser that is to provide customized content to the user. The user list comprises the definition and one or more members each identified by user-specific data. The user list is stored in a table of user lists and where the user specific data identifies the user. The user specific data is a global identifier associated with the user in an advertising serving system. Determining additional data includes retrieving data based on information associated with the user. Retrieving data includes retrieving data based on a location of the user. Retrieving data includes retrieving data from a third party. Retrieving data includes determining additional information about the user and retrieving additional data based on the additional information. The additional information is location information. The additional data is weather information in a location associated with the user. The additional information relates to an ownership of a particular type of account including certain assets and where the additional data is change data of a value or holding in the account. The context relates to a current condition associated with an environment in which the user is operating. Providing the additional data and the user list definition data includes providing data to subscribers to the user list for use in targeting content to the user. Targeting includes adjusting bids in real time. Targeting includes customizing content to be presented to the user.

The details of one or more embodiments are set forth in the accompanying drawings and the description below. Other features and advantages will be apparent from the description and drawings, and from the claims.

### DESCRIPTION OF DRAWINGS

FIG. 1 is a schematic diagram of an example system for providing and using shared data.

FIG. 2 is a schematic diagram of example user lists.

FIG. 3 is a flow diagram of an example process for joining user list definition data with additional data in response to receiving a request for content from a user.

FIG. 4 is a diagram of an example sequence of operations that are centered around an ad server that uses user list information joined with external data to serve an ad with customized content.

FIG. 5 shows an example of a computer device and a mobile computer device that can be used to implement the techniques described here.

Like reference symbols in the various drawings indicate like elements.

### DETAILED DESCRIPTION

Advertisers, publishers, and service providers generally may wish to exchange data for purposes of implementing a meaningful way of providing information and/or services (e.g., advertising content) to online users. If specific content is determined to be meaningful to a particular user, then the user may wish to access the content, purchase the content, or otherwise interact with the content. This interaction can provide revenue to the content provider (e.g., advertiser, publisher or service provider). If a particular content provider (e.g., advertiser, publisher, or service provider) can collect data about how specific content may or may not be meaningful to users (i.e., in the form of a user list), the collected data may be used by others in a variety of ways. One use relates to selecting targeted content. Other uses are possible, such as in adjusting bids in an auction based, for example, on user lists that indicate specific content is of interest to one or more users. User lists can be published, sold, licensed or otherwise accessed to assist in providing personalized content to the specific users and increasing revenue for a content provider.

User lists can represent specific user information pertaining to predefined categories. The categories can be defined by the data owners. For example, a user list may include data about one or more users which characterizes the users to a category (e.g., homeowner, craftsman, DVD renter, etc.) to allow targeting of the users by, for example, publishers or advertisers. In some implementations, the user lists can be used to target relevant advertising content.

User lists can be generated and exchanged according to a number of rules, and those rules can be used to market particular user lists to specific consumers. The rules can employ methods of assigning users to particular user lists. Such rules can provide a logical categorization of data, information, or services for the purposes of determining which data content in the user lists is particularly relevant to a number of users.

Methods are described for associating user specific information with one or more user lists that are owned or maintained by a data owner. An association between the user-specific data and the user lists is made. The association can be exploited, for example, for real-time bidding in response to requests for content or to customize content to be provided to a specific user. Other uses of the user list information and associations are possible.

In some implementations, user lists can be coupled with other data to discern a “context” of the user to which content is to be served. Examples of “context” include the weather in the user's area (hot/cold, clear/raining/snowing, etc.), user stock portfolio conditions (e.g., up/down), etc. Content that is provided in context may provide more timely and useful information to the users. Moreover, context information can be useful when selecting, customizing, or bidding on ads.

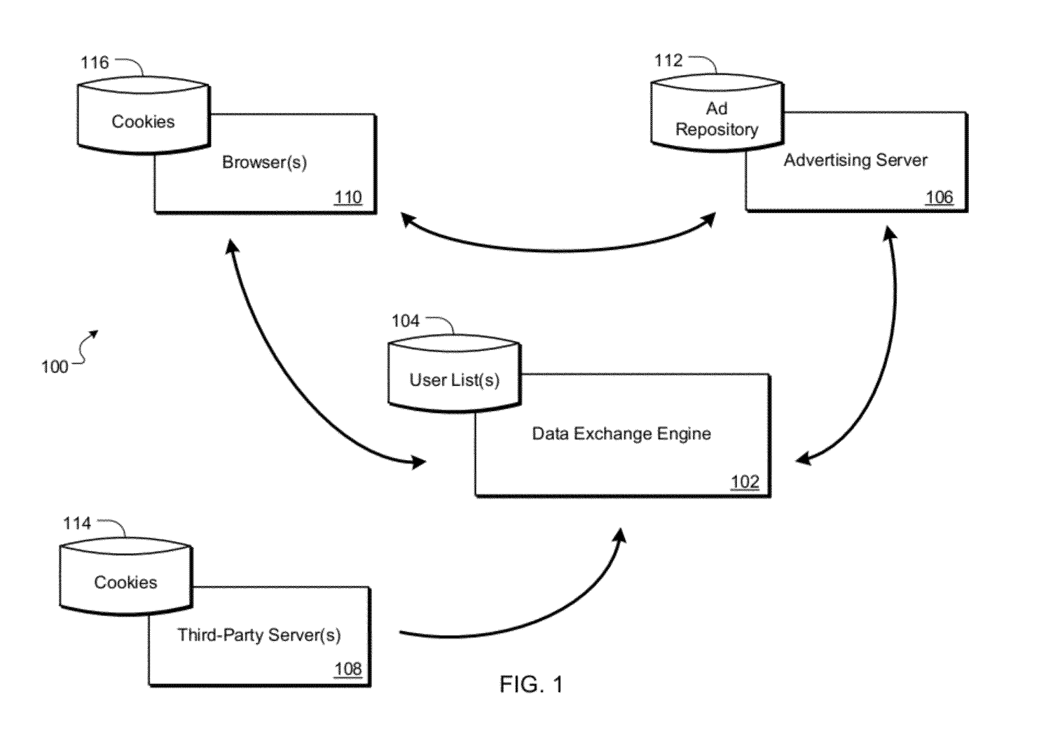

FIG. 1 is a schematic diagram of a system 100 for providing and using shared data. The shared data can, for example, include user lists detailing a number of predefined categories pertaining to specific users. The categories can be defined by or relate to user information including, but not limited to, browser history, user selections, cookie information, user-provided preferences, purchase histories, web search data, or other data (i.e., where the user has provided permission for the storing and/or collecting of such data). In some implementations, a user list is owned by a data provider that gathered the information in a respective user list. In some implementations, the user lists can be shared with other entities, such as for example using a data exchange. For example, the user lists can be shared amongst advertisers, third-party service providers, or third-party advertisers, data aggregators, and other online users.

The user lists can be provided to the data exchange and maintained by the data exchange and/or by the data owners. User lists can be updated as appropriate to either refine the category/categories associated therewith or the users that are members of a given list. Management of user lists is described in greater detail below.

The system 100 includes a data exchange engine 102 for providing an interface for advertisers and other consumers to discover and/or license user lists 104. The data exchange engine 102 can be configurable to maintain, update, present, license, sell or otherwise manage one or more user lists based on owned or permissioned data. The generated user lists can include user-specific associations characterizing specific online user behavior. The associations can be used, for example, to provide personalized content from an advertising server 106, a third-party server 108, or other content provider. The data exchange engine 102 as described here may parallel the functionality of an online advertisement exchange system for active targeted online advertisers, for example.

In some implementations, the data exchange engine 102 can create an exchange between owners of permissioned data and consumers of such data. Consumers of the permissioned data can include advertisers that seek to target particular categories of users. In some implementations, the data exchange engine 102 provides a mechanism for a provider of advertising placement services in targeted online advertising to make available additional third-party data sources to buyers of advertising space. In some implementations, the data exchange engine 102 can provide user lists to publishers, syndicates, and other data providers for various purposes, including the targeting of advertising content to users.

The data exchange engine 102 can provide an interface for data owners to securely view and manage their own data (i.e., manage a user list). For example, a data owner can generate and store information in a user list by entering data both manually and automatically. Other entities may be permitted to enter/maintain information in a user list. Publishers can also extract data for direct sales models or other marketing plans. Although computer hardware is not depicted in the data exchange engine 102, processors, memory, and other processing components may be included.

The advertising server 106 can provide advertising content to any number of browsers 110 via the data exchange engine 102 or directly. In addition, the advertising server 106 can be configurable for receiving advertising content requests and providing advertising content to requesting users. In operation, the advertising server 106 can select advertisements targeted based on one or more criteria and in view of data that is included in one or more user lists. The advertising server 106 can also provide access to other storage elements, such as ad repositories, in the example shown as ad repository 112. The ad repository 112 can be used to store advertising content associated with particular keywords, bidding criteria, advertisers, and targeting criteria. Data storage elements may include any one or combination of methods for storing data, including without limitation, arrays, hash tables, lists, and pairs. The advertising server 106 can access other similar types of data storage devices, such as user lists 104, for example. While reference is made to providing advertisements, the advertising server 106 can provide other forms of content.

In some implementations, advertisers can work with data providers to purchase or license user lists for purposes of targeting certain categories (e.g., demographic categories, interest categories, preference categories). The user lists can be analyzed for quality and other considerations. The advertisers can use the user lists for determining targeting criteria or to modify current bids, for example. In one example use case, an advertiser can subscribe for a period of time to a user list. The user list itself may be defined as being associated with a certain category (e.g., Internet shoppers interested in buying a sports car) of users. Requests for advertisements can be received by the advertising system, and the data exchange can be used to determine for a given user to which user lists the user is subscribed. In a real-time bid example, the advertisers that have subscribed to the user lists may be presented with the request (and necessarily information that the users satisfy the category(ies) associated with the user list(s)), and then may adjust/submit bids in consideration of such information. This is just one example of a use for the user list data.

The third-party servers 108 can provide third-party services to any number of browsers 110 via the data exchange engine 102. For example, the third-party servers 108 can provide web services, advertising services, or external APIs (application programming interfaces) to connect to a third-party server. The third-party servers 108 can include, for example, one or more servers executing a search engine application program. In some implementations, the third-party servers 108 can include a related information server or an advertising server. Third-party servers 108 can track user activity using cookies 114.

The browser 110 represents a user browsing the Internet. The browser 110 can access any website available on a network belonging to a person, or any other type of entity such as a company, enterprise, etc. For example, in FIG. 1 browser 110 can access a service or website. The service or website can be hosted by the third-party server 108, or alternatively by another server associated with system 100. A user can employ the browser 110 to search the Internet for services, information, or merchandise. The browser 110 can track user activity using, for example, cookies 116.

In some implementations, the advertising server 106 includes one or more advertisement customizers (not shown) operable to customize advertising content according to one or more user lists. In particular, an advertisement customizer can customize the display criteria, language, or other content of an advertisement according to user list information. For example, if a particular user list includes user-entered searching pertaining to purchasing a vehicle, the advertising server 106 can use the user-entered searching information (e.g., a cookie stored from performing a web search in a browser) to customize the display or content of an advertisement. The customization can, for example, provide the user with a more relevant advertisement.

In operation and for each generated user list, the system 100 can store, for example in a table-based repository, a list of user lists for which a particular user belongs. The table-based repository can, for example, be represented by a proprietary distributed storage system having a multi-dimensional sorted map as described in the paper entitled “Bigtable: A Distributed Storage System for Structured Data” by Fay Chang, Jeffrey Dean, Sanjay Ghemawat, Wilson C. Hsieh, Deborah A. Wallach, Mike Burrows, Tushar Chandra, Andrew Fikes, and Robert E. Gruber, the content of which is incorporated herein by reference in its entirety. The table-based repository represents a distributed storage system for managing structured data that is designed to scale to a very large size (e.g., petabytes of data across thousands of commodity servers). Each user list in the proprietary database can be included in one or more tables having multiple dimensions (one of which may be a field for time, allowing for versioning and garbage collection).

The system 100 can provide an index to the table-based repository. The index can be represented by, for example, a user cookie. For example, the table-based repository may be a set of rows and columns where the rows represent cookies corresponding to particular users and the columns represent a characterization associated with the user list, such as particular categories, keywords, websites, or other descriptive data.

At some point, the user browser 110 can make a request for advertising content from the advertising server 106 or the third-party server 108. The data exchange engine 102 can retrieve a list of user lists from the table-based repository associated with a received request from a given user and provide the request to identified consumers of the user lists. Any subsequent processing of the request can use the list, for example, for targeting, advertising customization and bid generation. The list of user lists or portions of the list can also be transmitted to a real-time bidder to provide the bidder with pertinent information about one or more users. Other uses are possible.

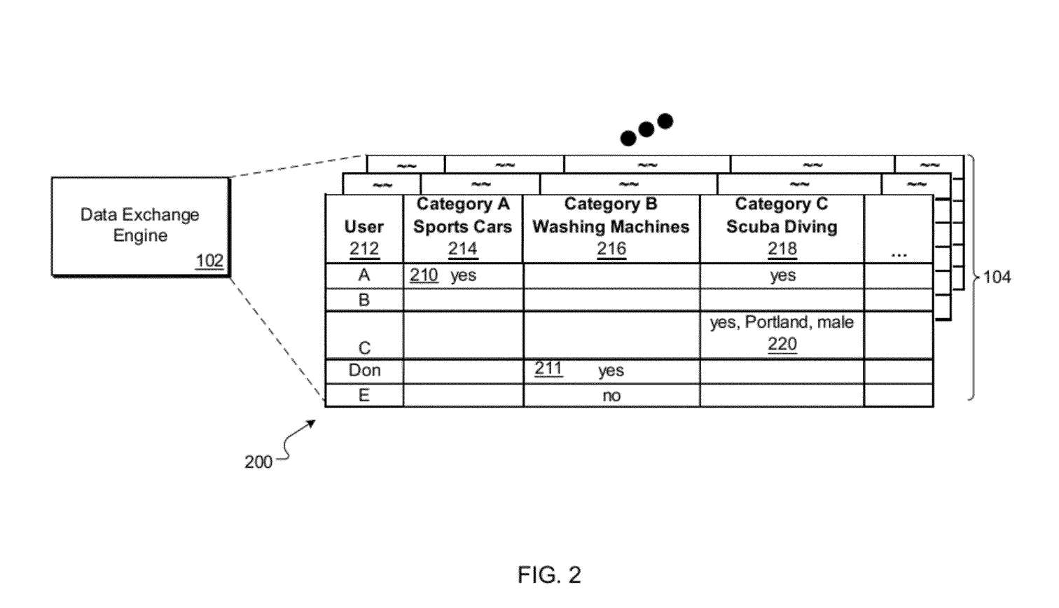

FIG. 2 is an example showing a schematic diagram of user lists 104 stored in a table 200. In this example, one or more entities (e.g., a web publishing entity that collected the user data) provided the user lists 104 to the data exchange engine 102. In some implementations, the user lists 104 in the table 200 are all provided by a same entity. In some implementations, the user lists 104 in the table 200 can include user lists owned/associated with different entities. In some implementations, users create their own user lists and provide the lists to the data exchange engine 102. For example, users can format content in user lists according to personal preferences and offer the user list data to the data exchange engine 102 for publication, management and use in targeting content to users. The data in the user lists 104 is developed, for example based at least in part on user-provided, searching and browser data. In this example, the data exchange engine 102 can manage the user lists 104 which details users 212 A-E. In some implementations, the table 200 can be indexed by a user identifier, such as the users 212 column.

In the example shown, each row represents a single user. A user identifier (not shown) can be used to identify a user. The user identifier can be a user identifier associated with a user in a domain associated with the entity that owns/provides the data (i.e., a local identifier). In some implementations, such as those where plural different entities provide user lists that are stored in a single table, the user identifier can be of the form of a global identifier associated with the user, such as an identifier that the advertising system assigns to the user. Global identifiers can be associated with “local” entity identifiers and mapped such that requests that include a local entity identifier can be associated with the global identifier and hence, can be associated with user lists associated with plural entities. As a user can be associated with multiple user lists owned by different data owners, global identifiers can help to tie together those user lists for that user.

In the example shown, each column represents a user list that includes a characterization (sometimes referred to as a definition), such as by way of a particular category(ies), keyword(s), website(s), demographic(s), interest(s), or other user classification. Example characterizations in the table 200 include sports cars, washing machines, and scuba diving. The characterization can include descriptors, such as keywords, that describe a given category. Each characterization may embody the combination of plural separate categories or subject matter. For example, the characterization sports cars, may embody those individuals that visited a web site that were interested in cars and those that were particularly interested in sports cars (which themselves represent two different categories). In some implementations, logical combinations of categories or subject matter can be used to define the characterization for a given user list.

Columns 214-218 of the table 200 each can identify, at least at a high level, a different characterization associated with a different user list. For example, the column 214 identifies users characterized by “Category A Sports Cars.” Other example characterizations and associated user lists are represented by column 216 (i.e., “Category B Washing Machines”) and column 218 (i.e., “Category C Scuba Diving”) to name a few examples. The table 200 can represent hundreds or thousands of characterizations and associated user lists.

In some implementations, each entry in the table 200 (i.e., the intersection of a row and a column) represents whether the user is a member of a given user list. For example, entry 210 indicates that user A is interested in or associated with a user list that has the characterization of sports cars, and entry 211 indicates that user Don is interested in or associated with a user list that has the characterization of washing machines. In some implementations, other data may be included in the entry. Other data can include geo-location data, cookie data, further personal data related to the user and known by the data owner, example web pages or example content (e.g., content surfed by the user), keyword searches, location data, website data, side vertical data, page vertical data, formatted text strings (where the data owner may include data related to the particular user in accordance with a definition set by the data owner (e.g., a series of bits that are set or not depending on the individual user's data for things like demographics, other interests, or other data that is different from the characterization but may be of use in targeting information to the particular user)) or other data. For example, entry 220 includes an indication that user C is not only a member of the user list associated with category C (scuba diving) but also that the user is located at a particular location (e.g., lives in Portland) and is a member of certain demographic groups (e.g. is male).

Identification of user lists to which a person belongs can be made by the data exchange engine 102 when a cookie or other user identifiable information is received. In some implementations, the data exchange engine 102 uses the cookie or user identifying information as an index to the user lists 104. For example, the data exchange engine 102 can cross reference received user identifier data with particular user list information to determine an association between user list data and the cookie data/user information. As shown in user lists 104, a user (A) showed an interest in user list A which is characterized by the keywords “sports cars”. For example, the user may, as part of a session with a given data provider, have provided a request to view sports cars made by Lexus such as providing a keyword search for “Lexus sports cars.”

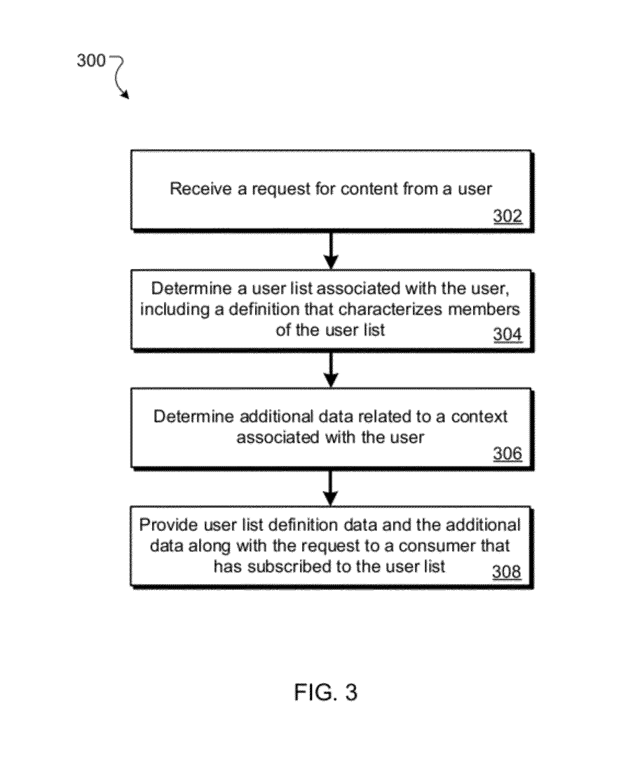

FIG. 3 is a flow diagram of an example process 300 for joining user list definition data with additional data in response to receiving a request for content from a user. The process 300 may be executed, for example, by the data exchange engine 102 shown in FIG. 1 in order to join a user list with external data to provide customized content in an ad. More or fewer participants may be involved.

At stage 302, a request for content is received from a user. In some implementations, the request for content can be a request to serve an ad, for example, that the data exchange engine 102 receives as a result of a user (e.g., Don) who is browsing the Internet. Prior to the request to serve the ad, Don's browser may initially display search results that have been received in Don's browser in response to his search query, such as a query for area appliance stores (e.g., keywords “major appliances”). Don may formulate the query to search for a replacement washing machine, for example, and may even include “washing machines” in the query. The search results may contain several entries for area appliance stores, and Don may select (e.g., click on) one of the search results entries. For example, one entry can be for Gary's Appliances Store, and the entry can include the name of the store, an address and phone number, a map and driving instructions, a snippet that describes the store, a clickable link to a corresponding webpage, and so on. As a result of clicking on the search result, Don's browser can attempt to navigate to the webpage (e.g., www.garysappliances.com) that corresponds to the search result. In this example, the webpage www.garysappliances.com can be designed to include or embed one or more ads, each of which being an available impression that can be served, for example, by the ad server 106. Thus, in this example, the request for content received from the user Don is a request to serve an ad on www.garysappliances.com. This request can, for example, be received and processed by the data exchange engine 102 and/or other engines (e.g., by an advertising server engine).

At stage 304, a user list associated with the user is determined, including a definition that characterizes members of the user list. In the current example, referring to FIG. 2, the data exchange engine 102 can look up user lists 104 in the table 200 that are associated with Don. The look-up can employ user-specific data, such as the user's user identifier (e.g., “Don” or some other identifier as described above), as an index to the row of interest in the table 200. Further, information from, for example, a cookie on the user's computer (or information from the user's search query) can be used to associate the Category B Washing Machines user list with the user Don, an association depicted in FIG. 2 by the entry 211 in column 216, signifying that Don is a member of that user list. The data exchange engine 102 can make the association using the definition for Category B Washing Machines that characterizes members in the user list. In this example, the Category B Washing Machines user list is the user list that is determined, but other user lists, such as user lists associated with appliances in general, may be determined in addition or instead. In some implementations, multiple user lists can be determined, and the data exchange engine 102 can select the user list that is likely to be the best match or forward all matching information on to subscribers to the respective user lists.

At stage 306, additional data related to a context associated with the user is determined. In some implementations, determining the additional data related to a context can begin by (or include) examining information from one or more cookies on a user's (e.g., Don's) computer. For example, at least one cookie may contain the IP address associated with Don's computer. In some implementations, the data exchange engine 102 can use the IP address to pinpoint Don's geographic location, such as a small town in the Midwest. The data exchange engine 102 can also use this geo-location information to access the current weather for Don's area, such as from a third-party weather information server. At the time of Don's query, for example, the third-party weather information server may indicate that Don's small town is in the middle of a heat wave and the current temperature is in the 90's. Thus, in this example, the additional data related to a context associated with the user (e.g., Don) includes the current weather and recent conditions. The weather, in this case, is just one example of a current condition associated with the user's environment, but other examples can include other relevant local or current data such as concerts or other upcoming area events, recent local news stories, area road construction or other projects, and so on. In some implementations, the additional data that is determined can be another user list. For example, if user's current weather conditions include a hot temperature, stage 306 can determine a user list such as “Users with Hot Weather” which can include users in regions where hot weather is observed.

At stage 308, user list definition data and the additional data are provided along with the request to a consumer that has subscribed to the user list. Continuing with the current example, the data exchange engine 102 can provide the Washing Machines user list definition, the current weather conditions, and the ad request to a consumer (e.g., the particular ad server 106 that can serve the ad to www.garysappliances.com). The combination of information in this way essentially serves to “join” the user list with the external data. The ad server 106 that is selected by the data exchange engine 102 to receive the ad request and joined information can be a consumer (e.g., one of several ad servers 106) that has subscribed to the Washing Machines user list. In some implementations, in cases in which stage 306 determines another user list, the other user list can be included with the user list definition and ad request that are provided to the consumer

Using the information received, for example, the ad server 106 can create an ad having customized content based on the information. For example, in addition to including information in the ad that is related to various washing machines in which Don may be interested, the ad server 106 can provide details of a current sale or promotion on air conditioners. The selection of air conditioners is just one example customization that can occur based on the weather conditions where Don lives. Other ad customization can include products or services that may appeal to Don in light of the weather conditions. Furthermore, by knowing that Don's small Midwest town is in the middle of a heat wave, the ad server 106 can promote particular models of washing machines that operate efficiently or have “cool house” technology (e.g., they avoid heating the surrounding area). Other example contexts can be time-based. For example, consider the case in which Don happens to be surfing the Internet around dinnertime and is a member of a user list characterized by a liking for Asian food. In this case, a customized ad that can be served to Don may include information for a local Asian food restaurant that delivers and (on Don's hot day of weather) offers a discount on cold beverages that can be added to the meal.

The example that was just described uses Dan's current weather conditions and time-of-day as the additional data related to a context associated with the user, but still other contexts can also be used for targeting ads. For example, a combination of information from other sources, such as cookies on Don's computer or information obtained from third-party sources may be used to determine context. For example, information may be available that indicates that Don's current stock portfolio is on a downward trend. An ad server 106 can use this information to generate other customized ads for Don, such as ads for financial planners in Don's general area that are displayed, for example, when Don visits investment-related websites. Another example of customized content can include the situation in which up-to-the-minute, daytime information is available, such as a promotion at a nearby department or discount store.

In some implementations, local copies can be maintained for data that is obtained from external sources, such as at stage 306. In some implementations, the data exchange engine 102, for example, can maintain local copies of external data in one or more tables. To keep the information up-to-date, the data exchange engine 102 can query external data sources on a regular or scheduled basis, e.g., every one or two hours. One example type of data that can be obtained every few hours is the set of weather conditions (e.g., temperature, precipitation, etc.) that can be obtained from national weather service websites or other meteorological sources. In some implementations, the information can include forecasts for all US ZIP codes, and can be stored locally in files (or RDBMS tables, etc.) and overwritten as more current information is available and obtained. This type of information can be indexed in various ways, such as by state, city, county, latitude/longitude, ZIP code, or other ways. Similar weather-related information can be obtained and stored on a regular basis for non-domestic areas, including Canada, Mexico, North America, and countries or areas on other continents. In some implementations, the schedules by which a certain area's data is updated on a regular basis can depend on the population of the area and/or the number of potential computers to which ads may be served.

In some implementations, context information can include information that is known ahead of time. Examples include holidays, elections, and schedules (e.g., for schools, cities, etc.). This type of information, for example, can be combined with information from a user's cookie to create context-based ads for such promotions as “Back-to-School” sales, holiday or Spring Break rates on products and services (e.g., that match the user's memberships in particular user lists), and so on.

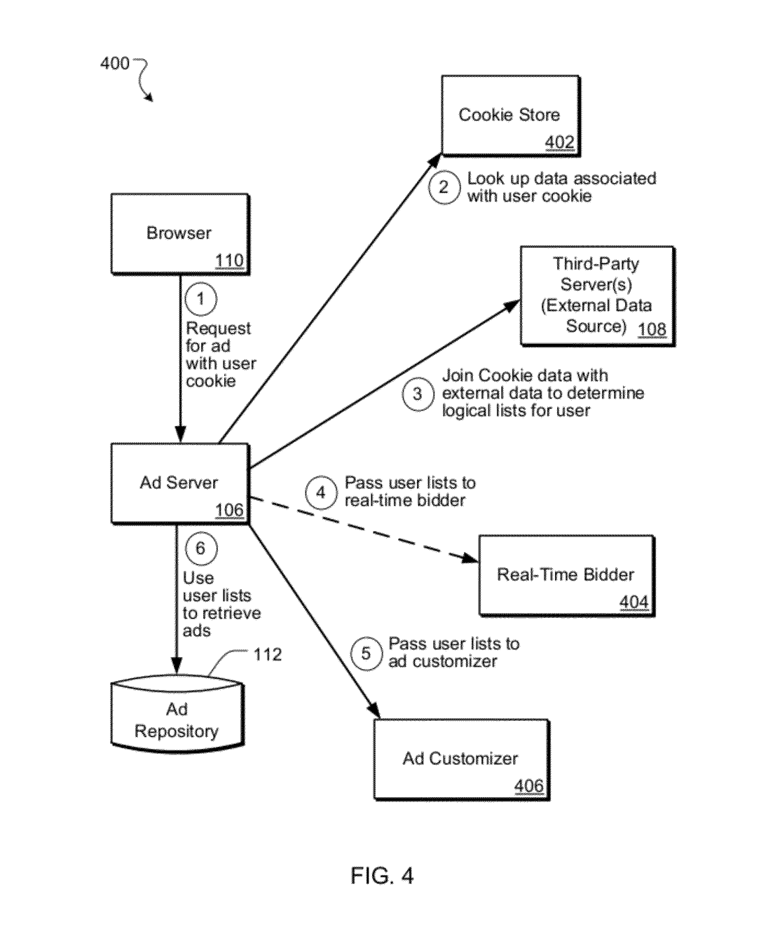

FIG. 4 is a diagram of an example sequence of operations 400 that are centered around an ad server 106 that uses user list information joined with external data to serve an ad with customized content. In step 1, based on user action on the user's browser 110, a request for an ad can occur. For example, the request can be similar to the request received at stage 302 of the process 300, such as a request for an ad related to washing machines or other major appliances that can occur when the user navigates to a webpage that hosts such ads.

In step 2, data in the cookie store 402 can be looked up, such as the user's (e.g., Don's) IP address. In step 3, information from the cookie can be used to obtain additional information, such as information from third-party servers 108 or other external data sources. In the present example, the additional information can include current weather conditions in Don's Midwest town. At this time, the user list associated with the user is also known (e.g., provided by the data exchange engine 102). For example, the user list for Don is the Category B Washing Machines user list. At this time, enough information exists so that a targeted ad with customized content can be created.

In step 4, which can be optional (e.g., as indicated by a dashed line), the information acquired in the previous steps, including the user lists, is passed to a real-time bidder 404. The bidding in this case can involve bids received from one or more consumers, or advertisers, who can bid on available impressions corresponding to, for example, the website to which the user is navigating. Using the targeting information, for example, bids can be adjusted in real-time. For example, a bid for an available impression may be significantly higher than otherwise because the targeted ad may be more likely to lead to a conversion. In some cases, bidding may occur without the use of the addition targeting information, and the additional targeting information can be used later as needed (e.g., to change the content of an ad).

In step 5, optionally and irrespective of whether bidding has occurred using the targeting information, user list and other information can be provided to an ad customizer 406. Returning again to the example involving ads provided to the user Don, the ad customizer 406 can customize the ad using available information, including current weather conditions in Don's town. The customized ad can be served right away and/or stored in the ad repository 112. In step 6, user lists can be used to access ads in the ad repository.

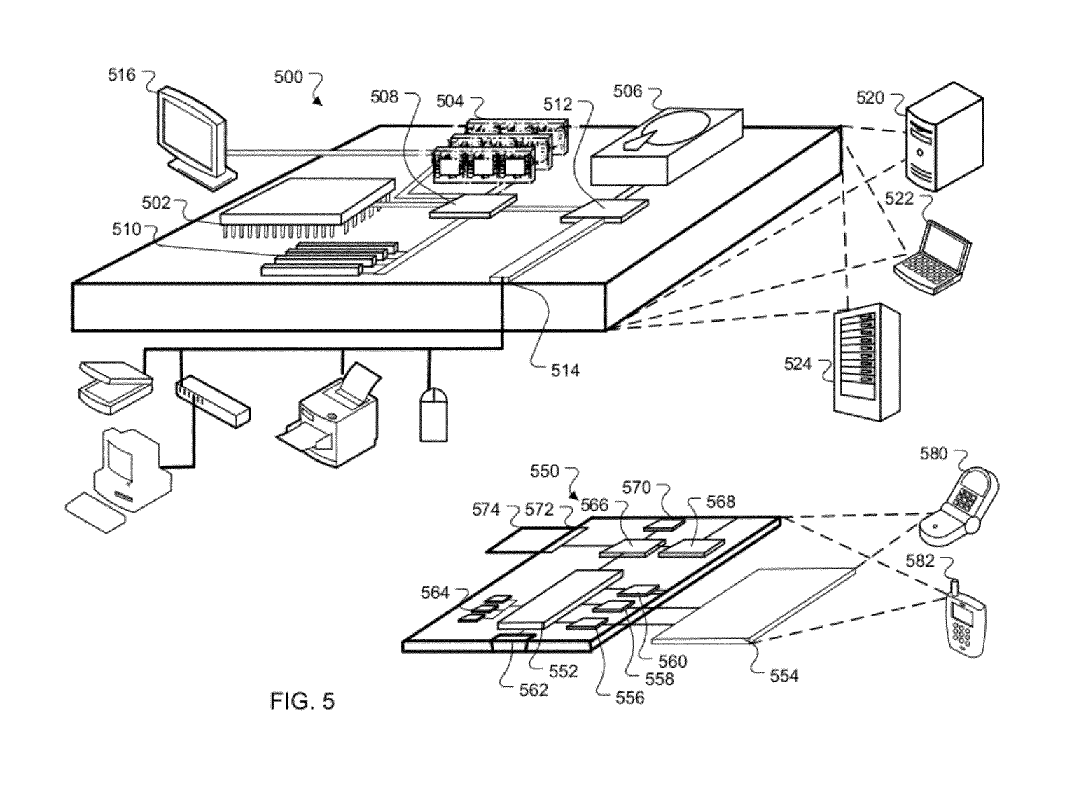

FIG. 5 shows an example of a generic computer device 500 and a generic mobile computer device 550 which may be used with the techniques described here.

Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, much of this document has been described with respect to advertisements, but other forms of future, content delivery may also be supported.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving a request for content from a user;
determining a user list associated with the user, the user list including a definition that characterizes members of the user list;
determining additional data related to a context associated with the user; and
providing user list definition data and the additional data along with the request to a consumer that has subscribed to the user list.

2. The method of claim 1 where the request is a request for an ad to be displayed to the user and where the consumer is an advertiser that is to provide customized content to the user.

3. The method of claim 1 where the user list comprises the definition and one or more members each identified by user-specific data.

4. The method of claim 3 where the user list is stored in a table of user lists and where the user specific data identifies the user.

5. The method of claim 4 where the user specific data is a global identifier associated with the user in an advertising serving system.

6. The method of claim 1 where determining additional data includes retrieving data based on information associated with the user.

7. The method of claim 6 where retrieving data includes retrieving data based on a location of the user.

8. The method of claim 6 where retrieving data includes retrieving data from a third party.

9. The method of claim 6 where retrieving data includes determining additional information about the user and retrieving additional data based on the additional information.

10. The method of claim 9 where the additional information is location information.

11. The method of claim 10 where the additional data is weather information in a location associated with the user.

12. The method of claim 9 where the additional information relates to an ownership of a particular type of account including certain assets and where the additional data is change data of a value or holding in the account.

13. The method of claim 1 where the context relates to a current condition associated with an environment in which the user is operating.

14. The method of claim 1 where providing the additional data and the user list definition data includes providing data to subscribers to the user list for use in targeting content to the user.

15. The method of claim 14 where targeting includes adjusting bids in real time.

16. The method of claim 14 where targeting includes customizing content to be presented to the user.

17. One or more computer storage devices comprising instructions that, when executed by one or more processing devices, cause the one or more processing devices to perform operations comprising:
receiving a request for content from a user;
determining a user list associated with the user, the user list including a definition that characterizes members of the user list;
determining additional data related to a context associated with the user; and
providing user list definition data and the additional data along with the request to a consumer that has subscribed to the user list.

18. A system comprising:
one or more processing devices; and
one or more memory devices comprising instructions that, when executed by one or more processing devices, cause the one or more processing devices to perform operations comprising:
receiving a request for content from a user;
determining a user list associated with the user, the user list including a definition that characterizes members of the user list;
determining additional data related to a context associated with the user; and
providing user list definition data and the additional data along with the request to a consumer that has subscribed to the user list.
